(19) United States
(12) Patent Application Publication
(10) Pub. No.: US 2022/0322622 A1
(43) Pub. Date: Oct. 13, 2022

(54) Irrigation Solenoid Valve Switch Assembly Operable on a Mesh Network

(71) Applicant: James Hobbs, Hobe Sound, FL (US)

(72) Inventor: James Hobbs, Hobe Sound, FL (US)

(21) Appl. No.: 17/227,409

(22) Filed: Apr. 12, 2021

(51) Int. Cl. A01G 25/16

(52) U.S. Cl. CPC A01G 25/165; G01S 19/13

(57) ABSTRACT

An irrigation solenoid valve switch assembly is operable on a mesh network. The assembly uses a mesh network to transmit valve command signals that control the timing and amount of water discharged through a solenoid valve in multiple agricultural zones. A solenoid valve regulates the flow of water. A clock, or agricultural controller, generates valve command signals that control the timing and amount of water discharged through the solenoid valve. A hub controller operatively connects to the clock. The hub controller transmits the valve command signals over the mesh network. A switch operatively connects to the solenoid valve. The switch receives the valve command signals to control the solenoid valve, in correspondence to the valve command signals. The switch has a rechargeable battery that feeds direct current to the switch for operation of the solenoid valve. Multiple relay signal repeaters carry the valve command signals across the mesh network.

### CROSS-REFERENCES TO RELATED APPLICATIONS

This CIP application claims priority from U.S. Nonprovisional application Ser. No. 17/217,260, entitled “IRRIGATION SOLENOID VALVE SWITCH ASSEMBLY OPERABLE ON A MESH NETWORK”, filed on Mar. 30, 2021, which application is hereby incorporated herein by reference in its entirety.

### FIELD OF THE INVENTION

The present invention relates generally to an irrigation solenoid valve switch assembly operable on a mesh network. More so, the present invention relates to a valve switch assembly that uses a mesh network to transmit commands that control the timing and amount of water discharged through a solenoid valve in multiple agricultural zones.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Often, In the field of crop irrigation, there is a natural need for automated software tools and applications that may assist an owner in site operation, proper irrigation of a site for proper delivery of nutrients or pesticides to plants, and accurate crop data collection. For example, it may be desirable to have access to an automated interactive system which could be used to optimize or update an irrigation schedule in real time based on data collected from a crop, metrological conditions, soil conditions, and type of crops being irrigated.

Irrigation systems supply water to soil. They are primarily used to assist in the growing of agricultural crops and maintenance of landscapes. Irrigation systems typically include valves, controllers, pipes, and emitters such as sprinklers or drip tapes. Irrigation systems are usually divided into zones based on the spatial resolution of the detection system, and irrigation is performed on that zone based on reflection from all the crop plants within that zone. Each zone may have a solenoid valve controlled via irrigation controller opening or closing irrigation zones. The irrigation controller may be a mechanical or electrical device signaling a zone to turn start irrigating a section of crop for a specific amount of time, or until it is turned off manually.

In many instances, command systems for commercial building and residential automation functions are available using a range of technologies. Among numerous technologies currently in use are X10®, Z-Wave® and Zigbee® technologies. Z-Wave technology is supported by a consortium of users and product developers, who have promulgated a set of Z-Wave communication standards that available through Zensys and the Z-Wave Alliance.

It is known in the art that Z-Wave is based on a mesh network topology. This means each (non-battery) device installed in the network becomes a signal repeater. Z-Wave is a wireless home automation protocol that operates in the 908.42 MHz frequency band. One of the features of Z-Wave is that it utilizes a type of network known as a “mesh network,” which means that one Z-Wave device will pass a data frame along to another Z-Wave device in the network until the data frame reaches a destination device. As a result, Z-Wave signals easily travel through most walls, floors and ceilings, the devices can also intelligently route themselves around obstacles to attain seamless, robust coverage.

Generally, Z-Wave has a range of 100 meters or 328 feet in open air, building materials reduce that range, it is recommended to have a Z-Wave device roughly every 30 feet, or closer for maximum efficiency. The Z-Wave signal can hop roughly 600 feet, and Z-Wave networks can be linked together for even larger deployments. Each Z-Wave network can support up to 232 Z-Wave devices provides the flexibility to add as many devices to the network.

Often, the Z-Wave network comprises a primary hub controller and at least one controllable device, known as a slave node, or more simply, a “node.” The controller establishes the Z-Wave network. The controller is the only device in a Z-Wave network that determines which Z-Wave nodes belong to the network. The primary hub controller is used to add or remove nodes from the network. The process of adding or removing nodes, also known as inclusion/exclusion, requires that the controller must be within direct radio frequency (RF) range of the node that is to be added or deleted from the network.

The user must interact with the controller and the device during this process. For example, to start the process, the controller and the device should be brought together in close physical proximity. Next, the controller is placed in an inclusion mode. Then the device is activated so that it will enroll in the Z-Wave network. After nodes are added to the network, the primary controller is responsible for determining communication routes to nodes, based on feedback from every node that the controller adds to the network. Additional nodes can be added at any time.

Other proposals have involved systems for controlling solenoid valves. The problem with these paging systems is that they do not utilize a flexible wireless communication system, such as Z-wave. Also, the hub controller cannot be controlled for powering on and restricting specific zones in the field. Even though the above cited systems for irrigating fields meet some of the needs of the market, a valve switch assembly that uses a mesh network to transmit commands that control the timing and amount of water discharged through a solenoid valve in multiple agricultural zones, is still desired.

### SUMMARY

Illustrative embodiments of the disclosure are generally directed to an irrigation solenoid valve switch assembly that is operable on a mesh network. The irrigation solenoid valve switch assembly uses a mesh network to transmit valve commands that control the timing and amount of water discharged through a solenoid valve in multiple agricultural zones.

In one embodiment, the irrigation solenoid valve switch assembly comprises a solenoid valve that is operable to regulate the flow of water. The irrigation solenoid valve switch assembly also comprises a clock that is operable to generate one or more valve command signals. The valve command signals are configured to control the timing and amount of water discharged through the solenoid valve.

In some embodiments, the irrigation solenoid valve switch assembly also comprises a hub controller that is operatively connected to the clock. The hub controller is configured to transmit the valve command signals over a mesh network. The irrigation solenoid valve switch assembly also comprises a switch that operatively connects to the solenoid valve. The switch is configured to receive the valve command signals. The switch is operable to control the solenoid valve in correspondence to the valve command signals. The switch has a rechargeable battery that feeds direct current (D/C) to the switch for operation of the solenoid valve.

In another aspect, the assembly further comprises multiple signal repeaters operable to carry the valve command signals across the mesh network.

In another aspect, the switch comprises a rechargeable battery.

In another aspect, the switch operates with direct current from the rechargeable battery.

In another aspect, the switch comprises a pair of wires configured to couple to corresponding wires for the solenoid valve.

In another aspect, the hub controller, or the switch, or both comprise an Internet Wi-Fi transceiver.

In another aspect, the solenoid valve comprises a water valve and a solenoid.

In another aspect, the water valve comprises an electrically controlled water valve.

In another aspect, the water valve is configured to open for discharging water, and close for restricting the discharge of water.

In another aspect, the assembly comprises multiple switches operable with multiple solenoid valves across multiple agricultural zones.

In another aspect, the signal repeaters are operatively disposed across the agricultural zones.

In another aspect, the hub controller comprises multiple channels corresponding to the agricultural zones.

In another aspect, the switch comprises a waterproof housing.

In another aspect, the switch has dimensions up to 6 inches in length, 3 inches in width, and 2 inches in thickness.

In another aspect, the mesh network includes at least one following networks: a Z-wave network, a Zigbee network, a packet radio network, a thread network, an Smash network, a SolarMESH project network, and a WiBACK wireless technology network.

One objective of the present invention is to create a more efficient irrigation system by regulating water discharge across multiple agricultural zones over a mesh network.

Another objective is to provide a switch that is universally operable with multiple types of solenoid valves.

Another objective is to minimize the charging requirements of the switch through use of a long-lasting battery.

Yet another objective is to use DC current, so as to negate the need for constant electrical power, as needed with an A/C power source.

Additional objectives are to provide a mesh network that operates the simple switch.

An exemplary objective is to position the signal repeaters strategically around multiple agricultural zones, so as to optimize the mesh network.

Additional objectives are to provide a strong signal, even with walls, fences, and barriers segregating the agricultural zones.

Yet another objective is to make the assembly portable over different types of agricultural and non-agricultural environments.

Yet another objective is to provide an inexpensive to manufacture irrigation solenoid valve switch assembly.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a diagram of an exemplary irrigation solenoid valve switch assembly operable on a mesh network across multiple agricultural zones, in accordance with an embodiment of the present invention;

FIG. 1 illustrates a perspective view of an exemplary irrigation solenoid valve switch assembly operable on a mesh network across multiple agricultural zones, in accordance with an embodiment of the present invention;

FIG. 2 illustrates a block diagram of an exemplary Z-wave network, in accordance with an embodiment of the present invention;

FIG. 3 illustrates a perspective view of an exemplary switch, in accordance with an embodiment of the present invention;

FIG. 4 illustrates a rear view of the switch shown in FIG. 3, showing a sectioned view of a battery and a transreceiver, in accordance with an embodiment of the present invention;

FIG. 5 illustrates a perspective view of the switch wired to a solenoid valve, in accordance with an embodiment of the present invention;

FIG. 6 illustrates a perspective view of an exemplary clock connected to a hub controller, in accordance with an embodiment of the present invention;

FIG. 7 illustrates a block diagram depicting an exemplary client/server system which may be used by an exemplary web-enabled/networked embodiment, in accordance with an embodiment of the present invention;

FIG. 8 illustrates a diagram of an exemplary global positioning system (GPS) operable with the assembly to help track the location of a solenoid valve, in accordance with an embodiment of the present invention;

FIG. 9 illustrates a perspective view of an exemplary a GPS controller positioned at or on the end of field for controlling selected location and tracking functions of the assembly, in accordance with an embodiment of the present invention;

FIG. 10 illustrates a diagram of an exemplary irrigation solenoid valve switch assembly operable on a mesh network across multiple agricultural zones, and an exemplary global positioning system (GPS) operable with the assembly to help track the location of a solenoid valve, in accordance with an embodiment of the present invention; and

FIG. 11 illustrates a perspective view of an exemplary faulty solenoid valve buried under the ground being tracked, in accordance with an embodiment of the present invention.

Like reference numerals refer to like parts throughout the various views of the drawings.

### DETAILED DESCRIPTION OF THE INVENTION

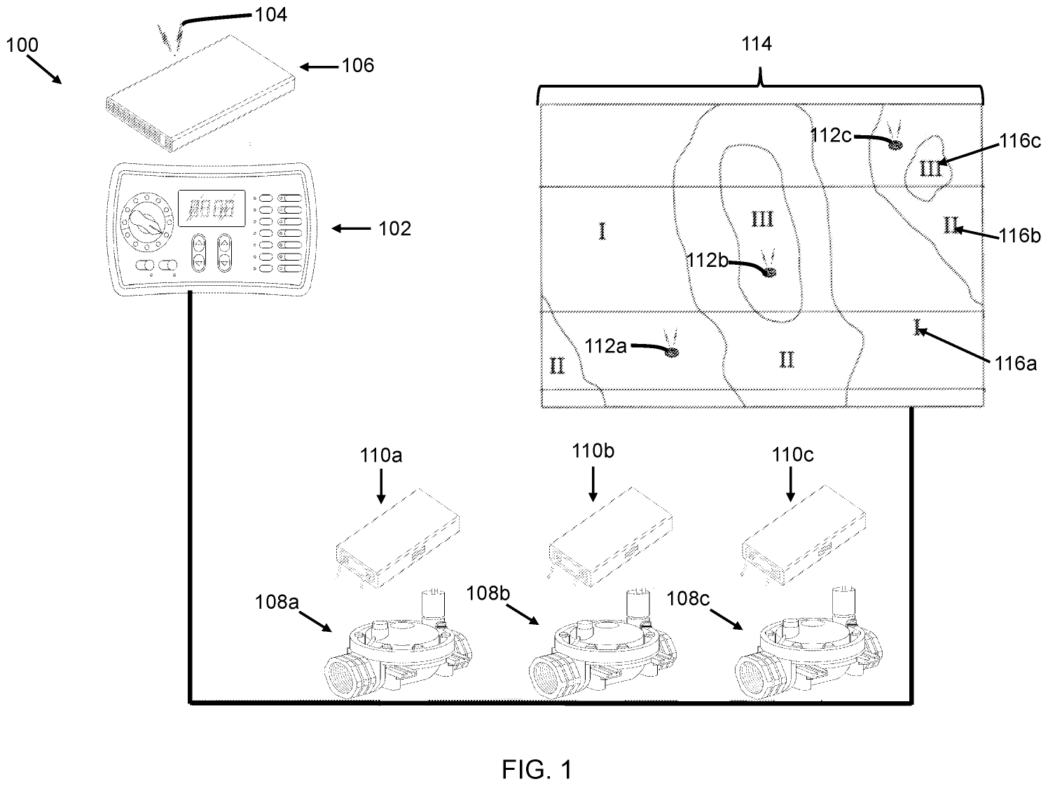

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

An irrigation solenoid valve switch assembly 100 operable on a mesh network is referenced in FIG. 1. The irrigation solenoid valve switch assembly 100, hereafter “assembly 100”, uses a mesh network 200 to transmit valve command signals 102 that control the timing and amount of water discharged through multiple solenoid valves 108a, 108b, 108c across multiple zones 116a-c in a field 114. In one non-limiting embodiment, the zone comprises an agricultural zone requiring irrigation. The field 114 may be divided into agricultural zones based on the spatial resolution of the detection system, whereby irrigation is performed on that zone based on reflection from all the crop plants within that zone. However, the zones may also encompass non-agricultural irrigation-related areas, including, without limitation, golf courses, sports fields, gardens, green houses, buildings, malls, and the like.

The solenoid valves 108a-c regulate the flow of water through the different zones 116a-c in the field 114. Any combination of solenoid valves can be used with one, or multiple zones in the field. For example, one solenoid valve can be used in one zone; or one solenoid valve can regulate water discharge in multiple zones; or multiple solenoid valves can regulate water discharge in one zone. For example, FIG. 1 illustrates three different zones 116a, 116b, 116c that receive water from one or more solenoid valves 108a-c. The solenoid valves 108a-c may include a solenoid and a water valve, as is known in the art of irrigation.

The assembly 100 is unique in utilizing a clock 102, or agricultural controller, that generates valve command signals 104 that control the timing and amount of water discharged through the solenoid valves 108a-c. Continuing with assembly 100, a hub controller 106 operatively connects to the clock 102. The hub controller 106 transmits the valve command signals 104 over the mesh network 200.

Multiple signal repeaters 112a-c are operatively disposed across the field to relay the valve command signals 104. Another unique feature is the use of multiple switches 110a-c, with each switch 110a, 110b, 110c correlating, or operatively connected to a solenoid valve. The switches 110a-c receive the valve command signals 104 from the hub controller 106, and convert the valve command signal into another signal or mechanical action to control a corresponding solenoid valve.

In this manner, the valve command signal 104 can control one or more of the solenoid valves in the different agricultural zones. Significantly, the switches 110a-c include a rechargeable battery 400 that feeds direct current (D/C) to the switch for operation of the solenoid valve. And as is inherent with a mesh network, multiple relay signal repeaters 112a, 112b, 112c carry the valve command signals 104 across the mesh network 200. In this manner, the assembly 100 enables selective discharge or restriction of water for each agricultural zone in a field.

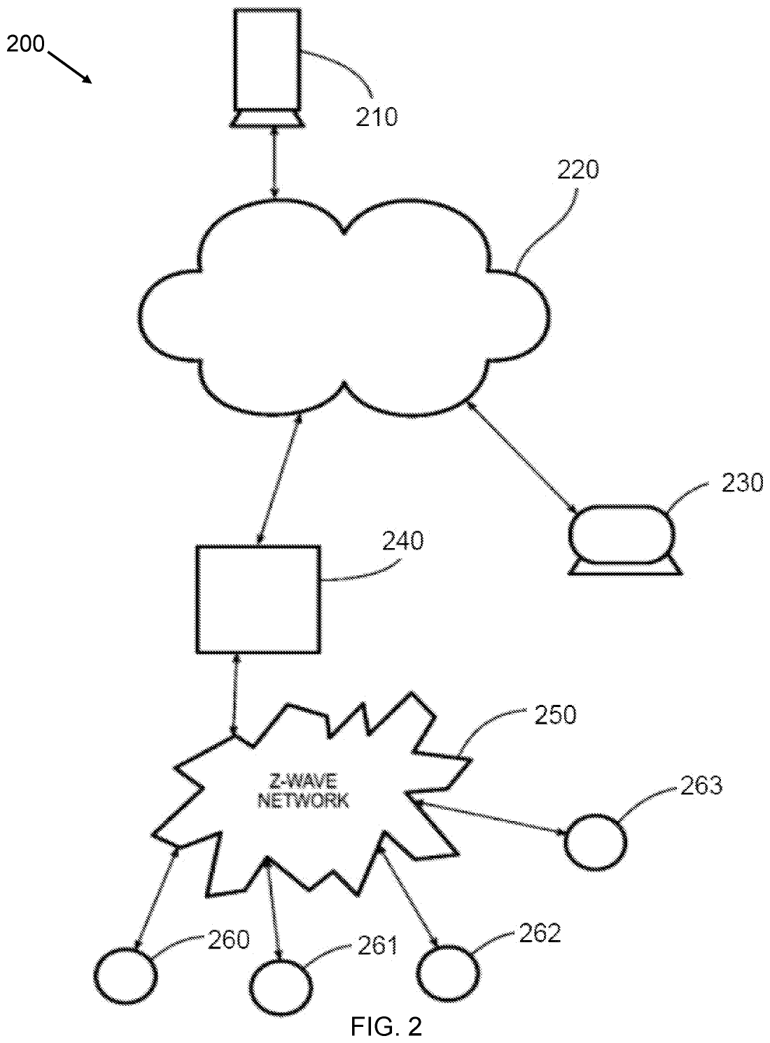

Looking now at FIG. 2, a primary operational function of the assembly 100 is the operation of irrigation valves over long distances in an agricultural environment, and over multiple agricultural zones, through use of a mesh network 200. The assembly 100 uses the mesh network 200 to transmit valve commands that control the timing and amount of water discharged through a solenoid valve 108a-c in multiple agricultural zones. The mesh network 200 may include, without limitation, a Z-wave network, a Zigbee network, a packet radio network, a thread network, a Smash network, a SolarMESH project network, and a WiBACK wireless technology network. By utilizing a mesh network 200, greater distances may be covered across fields, or other environments in which assembly may be operable.

In one non-limiting embodiment, the mesh network 200 is a Z-wave wireless communication protocol that comprises of low-energy radio waves to communicate between signal repeaters 112a, 112b, 112c, i.e., relay points, across the zones 116a-c. The Z-wave network can be controlled via the Internet with intercommunication between multiple relay points positioned throughout the agricultural zones.

As shown in schematic diagram of a mesh network 200, a Z-wave wireless communication protocol forms a Z-wave network 250. The Z-wave network 250 enables communications in the zones. It is known in the art that the Z-wave network 250 comprises a mesh network defined by low-energy radio waves. In some embodiments, the Z-wave network 250 includes a hub controller 104. The Z-wave network 250 comprises of a mesh network of low-energy radio waves to communicate between signal repeaters 112a-c, i.e., relay points, across the zones 116a-c.

The Z-wave network 250 can be controlled via the Internet with intercommunication between multiple relay points positioned throughout the zones. In some embodiments, the Z-wave network 250 may also include an Internet Wi-Fi transceiver. The Z-wave network 250 may also include multiple signal repeaters 112a-c that are operatively disposed across the zones. In other embodiments, the signal repeaters 112a-c are operatively disposed between tables and across walls in the zones.

Those skilled in the art will recognize that the numerous fences, trees, and hills in a field 114 require a mesh network to optimize communications between switches and solenoid valves in which infrastructure nodes, i.e., bridges, switches, and other infrastructure devices, connect directly, dynamically, and non-hierarchically. One exemplary mesh network is shown in a schematic diagram of the mesh network 200 (FIG. 2). The mesh network 200 includes Internet 220 and Z-wave network 250. As illustrated, a number of devices are in communication with each other over Internet 220, including a portal server 210, a user device 230 and a Z-wave networking device 240. User device 230 may communicate with portal server 210 through a web browser interface, using standard hypertext transfer protocol (HTTP).

In one embodiment of the mesh network 200, a portal server 210 communicates with Z-wave networking device 140 through lower layer Internet protocols, such as Transmission Control Protocol/Internet Protocol (TCP/IP) or User Datagram Protocol/Internet Protocol (UDP/IP). Z-wave networking device 240 conducts radio frequency (RF) communications with Z-wave networking devices 260-263. It should be noted that some devices 260-263 may be in direct communication with Z-wave networking device 240. As Z-wave network 250 is a mesh network, some devices 260-263 may communicate with Z-wave networking device 240 indirectly, through other devices 260-263.

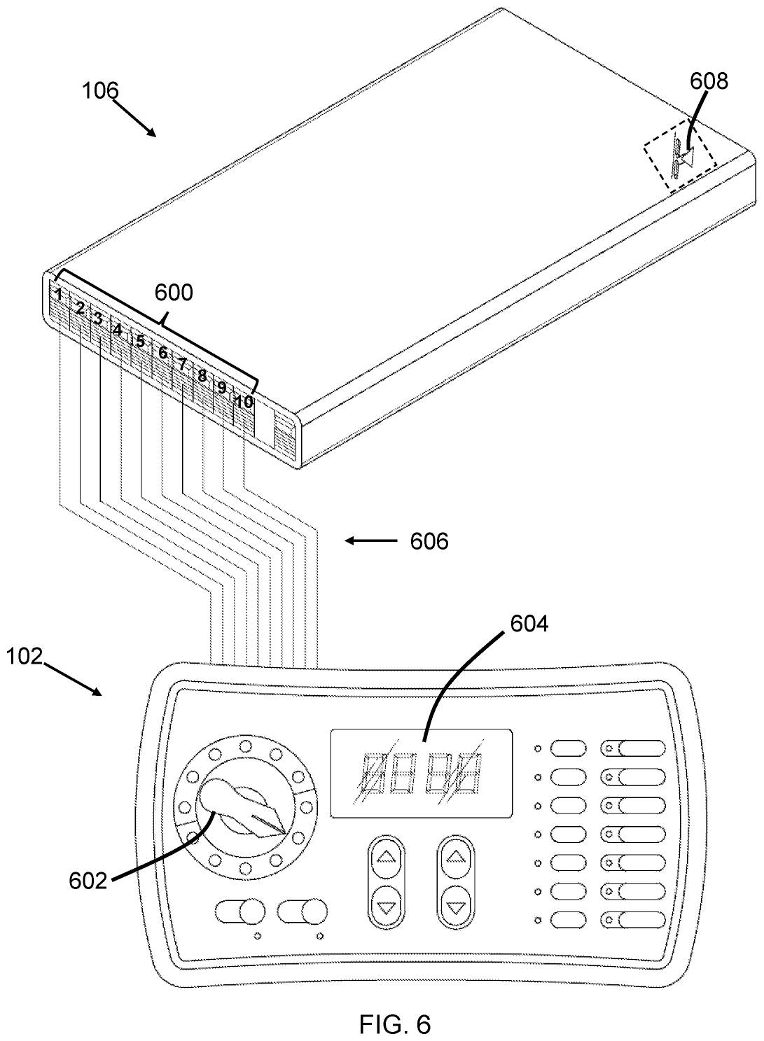

Looking ahead to FIG. 6, the assembly 100 comprises a clock 102 that is operable to generate one or more valve command signals 104. The valve command signals 104 are configured to control the timing and amount of water discharged through the solenoid valve. The clock 102 can have a control switch 602 and a display 604 to enable manual control of the timing and amount of water discharged from solenoid valves 108a-c. For example, FIG. 1 illustrates a perspective view of an exemplary irrigation solenoid valve switch assembly operable on a mesh network across multiple agricultural zones.

In some embodiments, the assembly 100 also comprises a hub controller 106 that is operatively connected to the clock 102. This connection may be through an NFC cord 606, or possibly through wireless means. The hub controller 106 is configured to transmit the valve command signals 104 over a mesh network. In some embodiments, the hub controller 106 comprises an Internet Wi-Fi transceiver to transmit the valve command signals 104.

In other embodiments, the hub controller 106 also comprises a processor, which may be operable with an algorithm. The algorithm in the processor is configured to calculate the timing of water discharge, and predetermined needs for specific plants. The processor is also configured to calculate the proximate position of the solenoid valves relative to each other, so as to optimize discharge of water onto the fields, and across the agricultural zones. In some embodiments, an algorithm, which is operable in hub controller 106, acts to regulate communications between the clock and the solenoid valve.

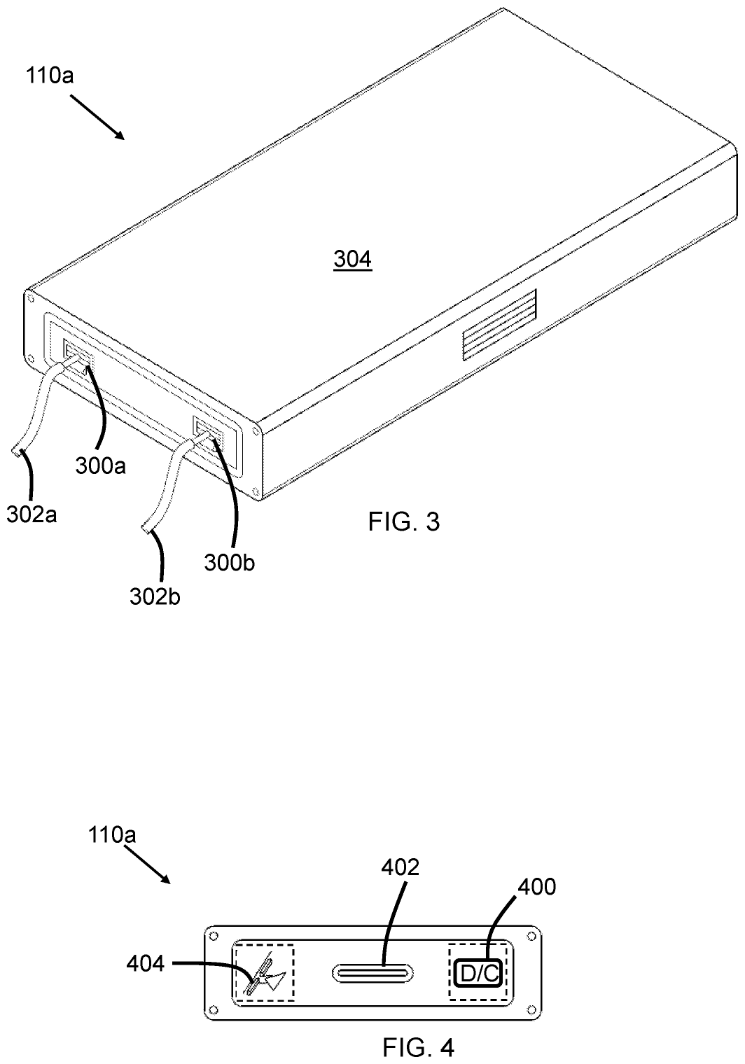

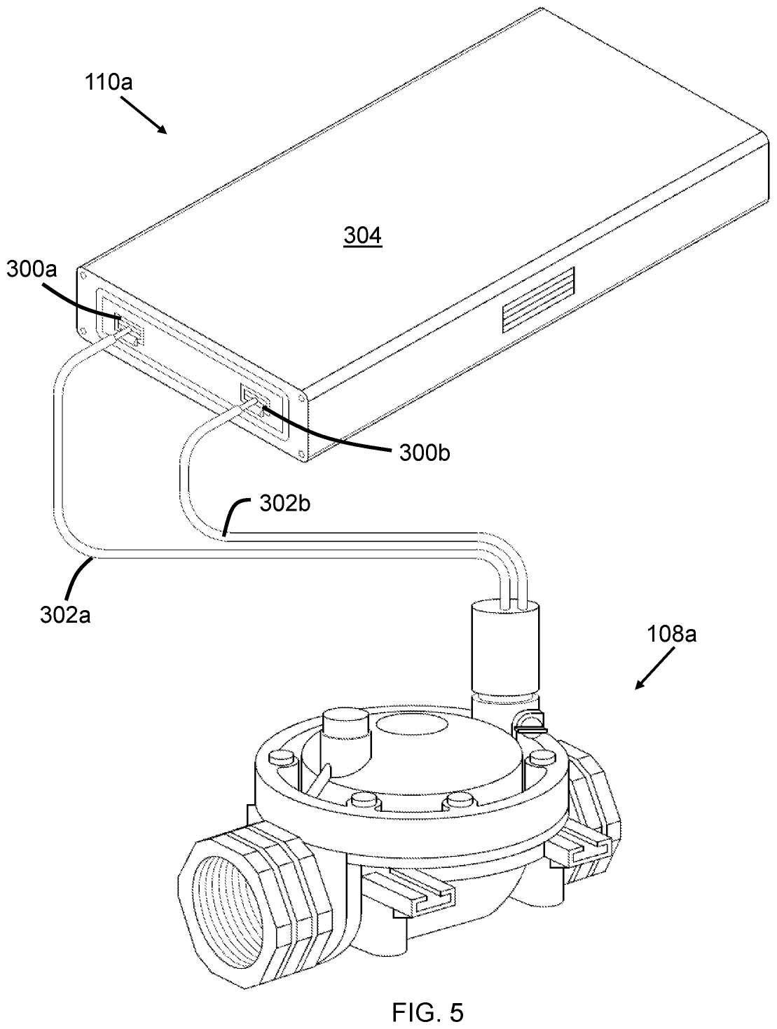

Looking at FIG. 3, the assembly 100 comprises a switch 110a that operatively connects to the solenoid valve 108a. The switch 110a is configured to receive the valve command signals 104. The switch 110a is operable to control the solenoid valve in correspondence to the valve command signals 104. Thus, in one possible embodiment, the switch 110a may have two wires 302a-b that couple to two correlating wires from the solenoid valve 108a to enable operational communication, and allow the solenoid valve 108a to register commands from the switch 110a. In some embodiments, the switch 110a comprises an Internet Wi-Fi transceiver 404 for receiving the valve command signals 104 from the control hub. This is, however, transmitted over the mesh network.

In some embodiments, the switch 110a comprises a waterproof housing 304. This can be useful in an agricultural environment where rain, pests, and irrigation flow can disperse moisture and contaminants into the switch 110a electrical components. In one non-limiting embodiment, the housing 304 has dimensions up to 6″ in length, 3″ in width, and 2″ in thickness—approximately the size of a smart phone. However, the assembly 100 is scalable, such that any dimensions, smaller or larger may also be used. The simplicity of the switch 110a allows it to be universally adapted to numerous types of solenoid valves.

Looking now at FIG. 4, the switch 110a comprises a rechargeable battery 400 that feeds direct current (D/C) to the switch 110a for operation of the solenoid valve. A charging port 402 in the back side of switch 110a enables a cord to charge the battery 400 accordingly. However, in alternative embodiments, alternating current (A/C) may be used. The use of D/C power is advantageous in that the need for constant electrical power, as needed with an A/C power source, is negated. The D/C power source from the rechargeable battery flows electric charge in one direction, towards the solenoid valve in a steady state of a constant-voltage circuit. This is preferable in the agricultural fields over the A/C, which is a time-varying voltage source, periodically reversing direction. In another embodiment, the switch 110a comprises a pair of wires 302a, 302b that are configured to couple to corresponding wires for the solenoid valve. Th wires 302a-b can operatively connect to a correlating pair of wire ports 300a, 300b in the switch 110a. The wires 302a-b may include a black and red wire, signifying ground and hot, for example.

In one possible, the solenoid valve comprises a water valve and a solenoid. The water valve is configured to open for discharging water, and close for restricting the discharge of water. The water valve may be an electrically controlled water valve. The solenoid can include a coil of wire used as an electromagnet that creates a magnetic field from the direct current from the battery. The generated magnetic field creates linear motion to move the water valve between the open and closed positions.

In one embodiment, shown in FIG. 1, the assembly 100 utilized multiple switches 110a-c operable with multiple solenoid valves 108a-c across the multiple zones 116a-c of the field 114. For example, ten solenoid valves operated by ten connected switches could be used for each agricultural zone. The first agricultural zone may grow rice, and thus require the most water. The second agricultural zone may grow alfalfa, and thus require lesser quantities of water for the alfalfa crop. The clock 102 deciphers, or is programmed to know, which crops require what quantity of water, and when the valves should be opened. In another example, a Z-Wave network can support up to 232 switches and correlating solenoid valves, which provides the flexibility to add as many switches to the network as the field can retain.

In some embodiments, the hub controller 106 transmits the generated valve command signals 104 from the clock 102. In one embodiment, multiple signal repeaters 112a-c are operatively disposed across the zones 116a-c, so as to transmit the appropriate signal 104 to the correlating solenoid valve. In yet another embodiment, shown in FIG. 6, the hub controller 106 comprises multiple channels 600 corresponding to the agricultural zones 116a, 116b, 116c. As illustrated, ten channels are shown.

In one possible embodiment, the channels 600 can be integrated or disconnected to selectively enable the solenoid valve to discharge or restrict water for the corresponding agricultural zone. For example, a channel #3 can be turned off to restrict communications between the hub controller 106 and the switch 110c for the solenoid valve in zone #3. Or, channels 1-4 can be turned on to initiate communications between the hub controller and switches and solenoid valves in agricultural zones 1-4. The channel can be manually switched on or off to enable or disable communications. This may include opening and closing a circuit for a transreceiver 608 in the hub controller 106; whereby the circuit regulates the transreceiver 608.

The switch 110a has a controller, or clock 102, that transmits commands across a mesh network. The switch 110a is a small, thin device, about the size of a smart phone that is configured to couple to a pair of outlet wires extending out from a solenoid that operates a valve. The switch 110a has a waterproof housing, a transreceiver, and a battery. The transreceiver receives the command signals 104 from the controller for operation of the valve, through the solenoid.

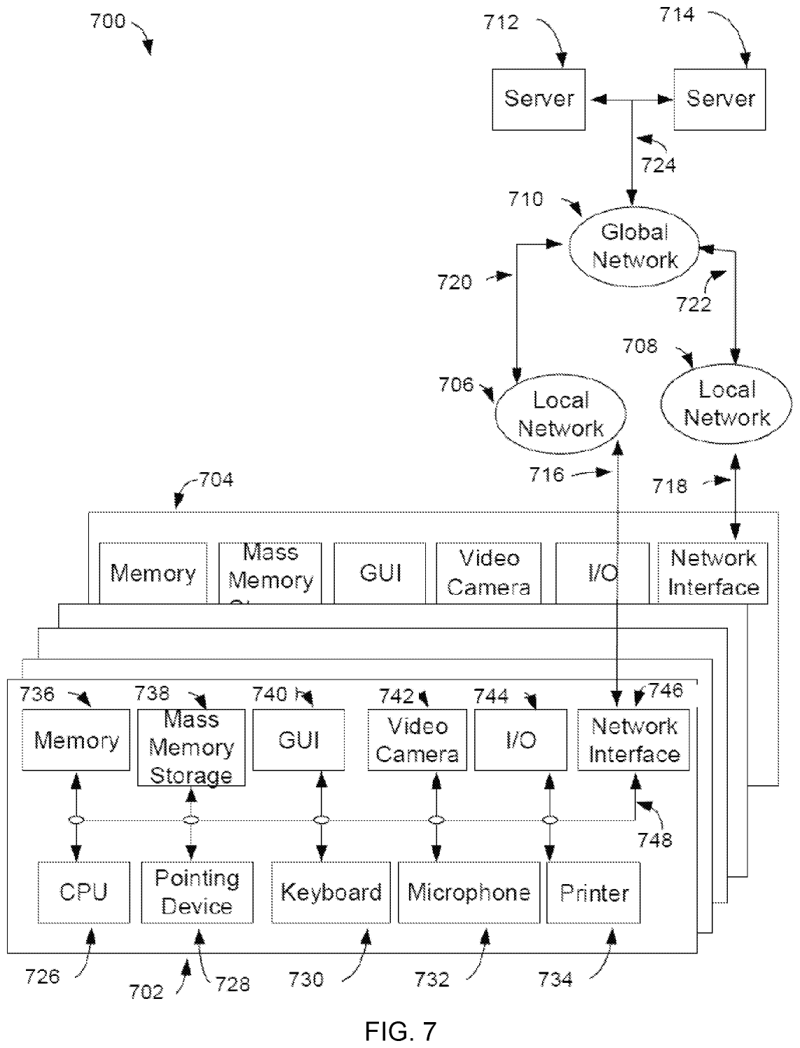

FIG. 7 is a block diagram depicting an exemplary client/server system which may be used by an exemplary web-enabled/networked embodiment of the present invention. A communication system 700 includes a multiplicity of clients with a sampling of clients denoted as a client 702 and a client 704, a multiplicity of local networks with a sampling of networks denoted as a local network 706 and a local network 708, a global network 710 and a multiplicity of servers with a sampling of servers denoted as a server 712 and a server 714.

Client 702 may communicate bi-directionally with local network 706 via a communication channel 716. Client 704 may communicate bi-directionally with local network 708 via a communication channel 718. Local network 706 may communicate bi-directionally with global network 710 via a communication channel 720. Local network 708 may communicate bi-directionally with global network 710 via a communication channel 722. Global network 710 may communicate bi-directionally with server 712 and server 714 via a communication channel 724. Server 712 and server 714 may communicate bi-directionally with each other via communication channel 724. Furthermore, clients 702, 704, local networks 706, 708, global network 710 and servers 712, 714 may each communicate bi-directionally with each other.

In one embodiment, global network 710 may operate as the Internet. It will be understood by those skilled in the art that communication system 700 may take many different forms. Non-limiting examples of forms for communication system 700 include local area networks (LANs), wide area networks (WANs), wired telephone networks, wireless networks, or any other network supporting data communication between respective entities.

Clients 702 and 704 may take many different forms. Non-limiting examples of clients 702 and 704 include personal computers, personal digital assistants (PDAs), cellular phones and smartphones. Client 702 includes a CPU 726, a pointing device 728, a keyboard 730, a microphone 732, a printer 734, a memory 736, a mass memory storage 738, a GUI 740, a video camera 742, an input/output interface 744 and a network interface 746.

CPU 726, pointing device 728, keyboard 730, microphone 732, printer 734, memory 736, mass memory storage 738, GUI 740, video camera 742, input/output interface 744 and network interface 746 may communicate in a unidirectional manner or a bi-directional manner with each other via a communication channel 748. Communication channel 748 may be configured as a single communication channel or a multiplicity of communication channels.

CPU 726 may be comprised of a single processor or multiple processors. CPU 726 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 736 is used typically to transfer data and instructions to CPU 726 in a bi-directional manner. Memory 736, as discussed previously, may include any suitable computer-readable media, intended for data storage, such as those described above excluding any wired or wireless transmissions unless specifically noted. Mass memory storage 738 may also be coupled bi-directionally to CPU 726 and provides additional data storage capacity and may include any of the computer-readable media described above. Mass memory storage 738 may be used to store programs, data and the like and is typically a secondary storage medium such as a hard disk. It will be appreciated that the information retained within mass memory storage 738, may, in appropriate cases, be incorporated in standard fashion as part of memory 736 as virtual memory.

CPU 726 may be coupled to GUI 740. GUI 740 enables a user to view the operation of computer operating system and software. CPU 726 may be coupled to pointing device 728. Non-limiting examples of pointing device 728 include computer mouse, trackball and touchpad. Pointing device 728 enables a user with the capability to maneuver a computer cursor about the viewing area of GUI 740 and select areas or features in the viewing area of GUI 740. CPU 726 may be coupled to keyboard 730. Keyboard 730 enables a user with the capability to input alphanumeric textual information to CPU 726. CPU 726 may be coupled to microphone 732. Microphone 732 enables audio produced by a user to be recorded, processed and communicated by CPU 726. CPU 726 may be connected to printer 734. Printer 734 enables a user with the capability to print information to a sheet of paper. CPU 726 may be connected to video camera 742. Video camera 742 enables video produced or captured by user to be recorded, processed and communicated by CPU 726.

CPU 726 may also be coupled to input/output interface 744 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 726 optionally may be coupled to network interface 746 which enables communication with an external device such as a database or a computer or telecommunications or internet network using an external connection shown generally as communication channel 716, which may be implemented as a hardwired or wireless communications link using suitable conventional technologies. With such a connection, CPU 726 might receive information from the network, or might output information to a network in the course of performing the method steps described in the teachings of the present invention.

In conclusion, irrigation solenoid valve switch assembly 100 is operable on a mesh network. The assembly uses a mesh network to transmit valve command signals that control the timing and amount of water discharged through a solenoid valve in multiple agricultural zones. A solenoid valve regulates the flow of water. A clock, or agricultural controller, generates valve command signals that control the timing and amount of water discharged through the solenoid valve. A hub controller operatively connects to the clock. The hub controller transmits the valve command signals over the mesh network. A switch operatively connects to the solenoid valve. The switch receives the valve command signals to control the solenoid valve, in correspondence to the valve command signals. The switch has a rechargeable battery that feeds direct current to the switch for operation of the solenoid valve. Multiple relay signal repeaters carry the valve command signals across the mesh network.

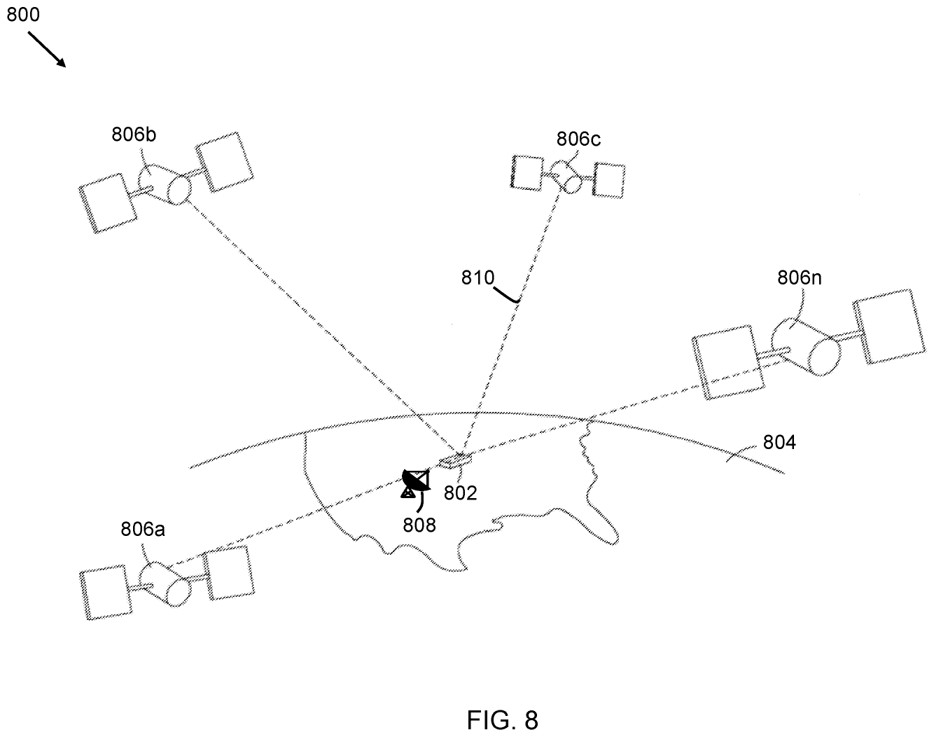

Turning now to FIG. 8, a global positioning system (GPS) 800 is operable with the assembly 100 to help track the location of the solenoid valve 108a when an event, such as a faulty solenoid valve, or required maintenance, occurs. Those skilled in the art will recognize that GPS is a system of at least thirty navigation satellites 806a, 806b, 806c, 806n circling the Earth 804. Working in conjunction with the signals transmitted by the navigation satellites 806a-n is a GPS module, or GPS receiver, as is known in the art. In the present invention, at least one GPS module 808 is integral and operatively connected to the solenoid valve and/or the hub controller to help identify the location of each in the field.

Thus, as is known in the art, when a solenoid valve 802, which is buried beneath the ground, has mechanical problems or maintenance requirements, the GPS system 800 works to indicate the location of the solenoid valve 802. The GPS module 808 is then operable to receive satellite signals from the GPS satellites 806a-n to determine a current location of the solenoid valve 802 as a function of the received satellite signals 810. Once the GPS module 808 calculates its distance from four or more GPS satellites 806a-n, the location of the solenoid valve can be determined. A technician may then dig under the ground at an accurate location to retrieve and remedy the faulty solenoid valve.

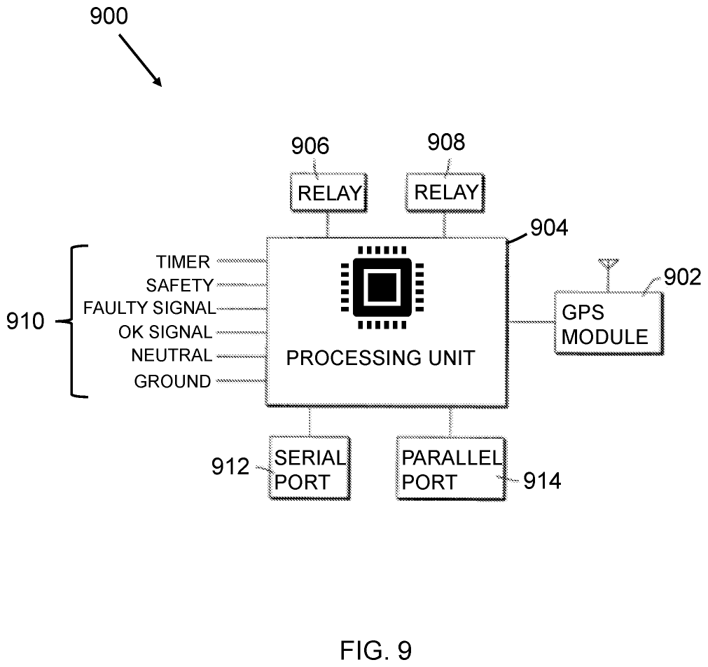

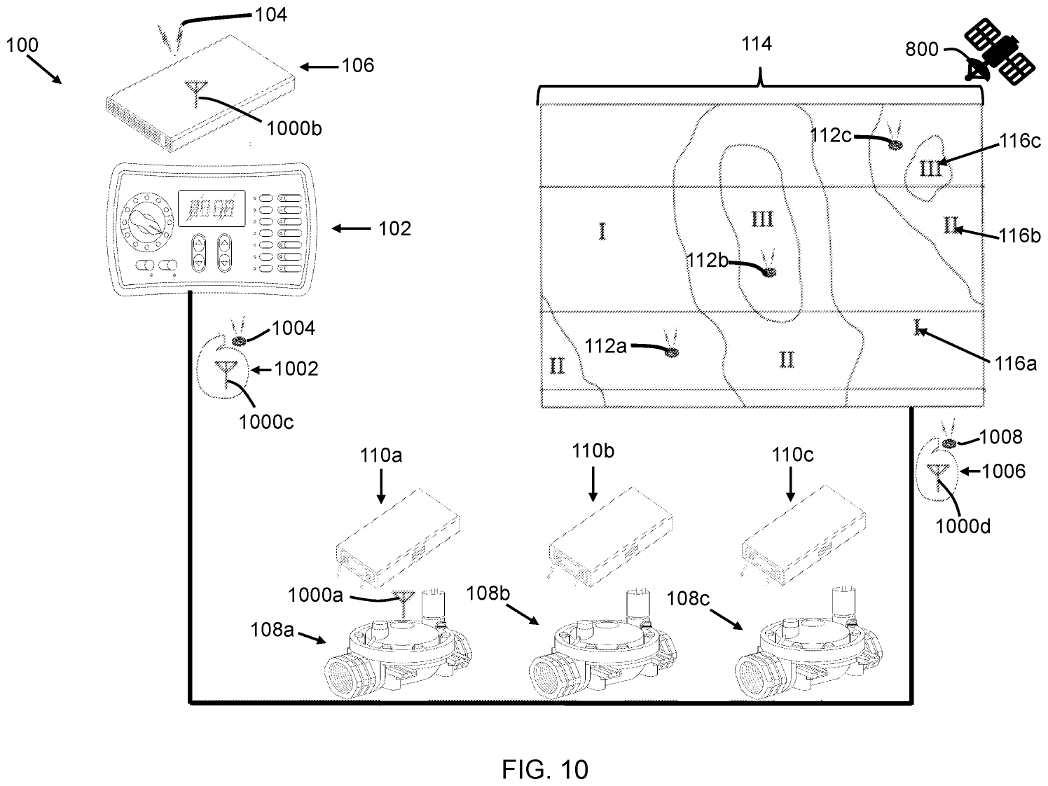

Looking now at FIG. 9, the assembly 100 may also include a GPS controller 900 positioned at or on the end of field 114 for controlling selected location and tracking functions of the assembly 100 independently from the hub controller 106. In one embodiment, the GPS controller 900 is operatively connected to a first and second GPS module 1000a, 1000b (See FIG. 10). The GPS controller 900 can be implemented with hardware, software, firmware, or a combination thereof, but may include the components illustrated in FIG. 9.

One possible embodiment of the GPS controller 900 comprises a location determining component 902, such as a GPS module and/or GPS receiver. The GPS controller 900 may also include a processing unit 904, one or more relays 906, 908, a plurality of inputs 910, an input port 912, and an output port 914. Those skilled in the art will recognize this circuitry for a GPS and other tracking and positioning systems.

In one embodiment, the aforementioned components of GPS controller 900 are enclosed in or supported on a weatherproof housing which protects against the elements, such as moisture, vibration, and impact. In yet other embodiments, the GPS controller 900 may also include a display screen and a power source such as a battery pack or solar cell. In yet another embodiment, GPS controller 900 is hardwired to a power source associated with the hub controller 106 or even the switch 110a.

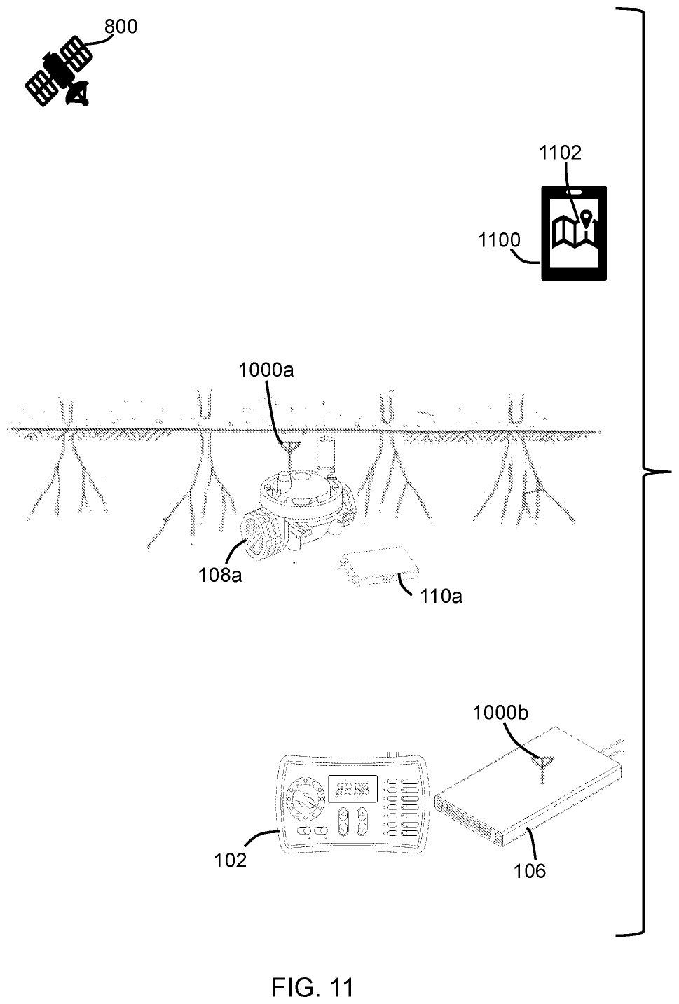

As referenced in FIG. 10, a first GPS module 1000a, or GPS receiver, is integrally connected to a solenoid valve 108a. The useful functionality for tracking, or locating a stationary solenoid valve is known in the art to be necessary, since solenoid valves used for irrigation are often buried beneath the ground. For example, FIG. 11 illustrates solenoid valve 108a and the accompanying switch 110a buried under the ground with the first GPS module 1000a attached thereto. In alternative embodiments, the first GPS module 1000a is connected to the switch that is hard wired to the solenoid valve, providing substantially the same locating capacity.

It is also instructive to note that the hub controller 106 is integrally connected and operational with a second GPS module 1000b, or GPS receiver. Similar to the first GPS module 1000a on the solenoid valve, the second GPS module 1000b receives satellite signals from a plurality of GPS satellites 806a-n in order to determine a current location of the hub controller 106 in relation to the solenoid valve 802 as a function of the received satellite signals 810 (See FIG. 10).

This secondary GPS module 1000b can be useful in large fields where many acres or miles separate the hub controller 106 from the solenoid valve 802. In alternative embodiments, the second GPS module 1000b is connected to the clock 102 that is hard wired to the hub controller 106, providing substantially the same locating capacity. The hub controller 106 and the connected clock 102 are in operational proximity to solenoid valve 108a, so as to enable transmitting the valve command signals 104 through the mesh network, as discussed above. In both cases, the solenoid valve and the hub controller 106 are locatable through use of GPS 800.

In operational use, a faulty solenoid valve 108a is identified through LED's in the hub controller that display specific colors to indicate an event, such as a faulty valve or maintenance being required for a valve or switch. A green LED illumination indicates the solenoid valve is fully operational. A yellow LED illumination indicates the solenoid valve is starting to show problems, or is nearing maintenance periods. A red LED illumination indicates the solenoid valve is faulty or nonoperational. Once a yellow or red LED illumination occurs, the location of the faulty solenoid valve may then be determined by the GPS 800.

Thus, after determining that the solenoid valve requires attendance, the first GPS module 1000a helps the technician track the exact location of the solenoid valve, which may be underneath the ground. In one embodiment, the technician has a communication device 1100 that displays a geo-map 1102 for visually indicating the location of the solenoid valve. Geo-map 1102 can include a digital map of the field, with icons depicting the location of landmarks and solenoid valves.

In another operational use, both the first and second GPS modules 1000a-b locate four or more satellites and calculate the distance to each satellite by timing a radio signal from each satellite to the receiver. In order to use this timing information the receiver, has to know the location of the satellites. Since the satellites travel in known orbit paths, the GPS receiver can receive and store the ephemeris and/or almanac that tells the receiver the location of the satellites at various times.

Thus, both the first and second GPS modules 1000a-b provide location information for their respective solenoid valve and hub controller by communicating with the satellites 806a, 806b, 806c, 806n that orbit the earth 804. Such GPS information may provide positioning accuracies that are superior to alternative technologies such as cellular cell-ID. And when combined with the mesh network, discussed above, the efficiency of transmitting valve control signals, and locating faulty solenoid valves creates an efficient irrigation operation.

Looking again at FIG. 10, the assembly 100 provides a wireless pump 1002 for controllably forcing water through a water line, and to the solenoid valves 108a-c. The wireless pump 1002 is controlled, wirelessly, by the hub controller 106, based on valve control signals generated at the clock 102. The wireless pump 1002 may also have a pump transreceiver 1004 for receiving the valve control signals. Thus, the hub controller transmits valve control signals to the wireless pump 1002 to pump water to the solenoid valve; and also transmits valve control signals to the switch to regulate opening and closing the solenoid valve.

As with the other components, the valve control signals to the wireless pump 1002 are sent across the mesh network. In one embodiment, the wireless pump 1002 comprises a third GPS module 1000c that enables the location of the wireless pump 1002 to be tracked. The third GPS module 1000c provides location information for the wireless pump 1002 by communicating with the satellites 806a, 806b, 806c, 806n that orbit the earth 804.

Similarly, the assembly 100 provides a wireless booster pump 1006 for controllably forcing water to the solenoid valves 108a-c over longer distances, such as pipes that extend many acres across the field. The wireless booster pump 1006 is controlled, wirelessly, by the hub controller 106, based on valve control signals generated at the clock 102. The wireless booster pump 1006 may also have a booster pump transreceiver 1004 for receiving the valve control signals. Thus, the hub controller transmits valve control signals to the wireless booster pump 1006 to pump water to the solenoid valve; and also transmits valve control signals to the switch to regulate opening and closing the solenoid valve.

As with the other components, the valve control signals to the wireless booster pump 1006 are sent across the mesh network. In one embodiment, the wireless booster pump 1006 comprises a fourth GPS module 1000d that enables the location of the wireless booster pump 1006 to be tracked. The third GPS module 1000c provides location information for the wireless booster pump 1006 by communicating with the satellites 806a, 806b, 806c, 806n that orbit the earth 804.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. An irrigation solenoid valve switch assembly, the assembly comprising:
a solenoid valve operable to regulate the flow of water;
a first global positioning system module integral in the solenoid valve, the first global positioning system module operable to receive satellite signals from a plurality of global positioning system satellites for determining a current location of the solenoid valve as a function of the received satellite signals;
a clock operable to generate one or more valve command signals, the valve command signals operable to control the timing and amount of water discharged through the solenoid valve;
a hub controller operatively connected to the clock, the hub controller operable to transmit the valve command signals over a network capable of supporting data communication selected from an Internet Wi-Fi transceiver, a local area network (LAN), a global network, a wide area network (WAN), a wired telephone network, a wireless network, and a mesh network, the mesh network including at least one of the following networks: a Z-wave network, a Zigbee network, a packet radio network, a thread network, a Smash network, a SolarMESH project network, a WiBACK wireless technology network, the hub controller comprising a plurality of LEDs capable of displaying a green LED illumination, a yellow LED illumination and a red LED illumination;
a switch operatively connected to the solenoid valve, the switch operable to receive the valve command signals, the switch operable to control the solenoid valve in correspondence to the valve command signals;
a communication device displaying a geo-map of a field where the solenoid valve is located, the communication device being operatively connected to the first global positioning system module;
wherein, in operational use, the plurality of LEDs of the hub controller is capable of displaying a plurality of specific colors to indicate a plurality of events, the plurality of specific colors and events comprising a green LED illumination to indicate the solenoid valve is fully operational, a yellow LED illumination to indicate the solenoid valve is starting to show problems, and a red LED illumination to indicate the solenoid valve is faulty or nonoperational; and
wherein, in response to a yellow LED illumination or a red LED illumination, the location of the solenoid valve is determined by the first global positioning system module, and the location of one or more of the hub controller and the clock is determined by the second global positioning system module;
whereby a solenoid valve which requires attendance may be located.

20. An irrigation solenoid valve switch assembly, the assembly comprising
a solenoid valve operable to regulate the flow of water;
a clock operable to generate one or more valve command signals, the valve command signals operable to control the timing and amount of water discharged through the solenoid valve;
a hub controller operatively connected to the clock, the hub controller operable to transmit the valve command signals over a mesh network; the hub controller further comprising a plurality of LEDs capable of displaying a green LED illumination, a yellow LED illumination and a red LED illumination; and wherein, in operational use, the plurality of LEDs of the hub controller is capable of displaying a plurality of specific colors to indicate a plurality of events, the plurality of specific colors and events comprising a green LED illumination to indicate the solenoid valve is fully operational, a yellow LED illumination to indicate the solenoid valve is starting to show problems, and a red LED illumination to indicate the solenoid valve is faulty or nonoperational;
a switch operatively connected to the solenoid valve, the switch operable to receive the valve command signals, the switch operable to control the solenoid valve in correspondence to the valve command signals, the switch comprising a rechargeable battery, whereby the switch is operable with direct current; and
multiple signal repeaters operable to carry the valve command signals across the mesh network,
whereby the assembly is operable with multiple switches and multiple solenoid valves across multiple agricultural zones,
whereby the signal repeaters are operatively disposed across the agricultural zones for transmitting the valve command signals through the mesh network, and across the agricultural zones,
whereby the hub controller, or the switch, or both comprise an Internet Wi-Fi transceiver, a transreceiver, and multiple channels, the channels corresponding to the agricultural zones, the channels operable to enable and restrict communications between the hub controller and the switches in corresponding agricultural zones.

21. An irrigation solenoid valve switch assembly, the assembly comprising:
a solenoid valve operable to regulate the flow of water;
a clock operable to generate one or more valve command signals, the valve command signals operable to control the timing and amount of water discharged through the solenoid valve;
a hub controller operatively connected to the clock, the hub controller operable to transmit the valve command signals over a mesh network;
a switch operatively connected to the solenoid valve, the switch operable to receive the valve command signals, the switch operable to control the solenoid valve in correspondence to the valve command signals, the switch comprising a rechargeable battery, whereby the switch is operable with direct current; and
multiple signal repeaters operable to carry the valve command signals across the mesh network; and
a wireless booster pump for controllably forcing water to the solenoid valve, the wireless booster pump being controlled wirelessly by the hub controller based on valve control signals generated at the clock, the wireless booster pump further comprising a booster pump transreceiver for receiving the valve control signals,
whereby the assembly is operable with multiple switches and multiple solenoid valves across multiple agricultural zones,
whereby the signal repeaters are operatively disposed across the agricultural zones for transmitting the valve command signals through the mesh network, and across the agricultural zones,
whereby the hub controller, or the switch, or both comprise an Internet Wi-Fi transceiver, a transreceiver, and multiple channels, the channels corresponding to the agricultural zones, the channels operable to enable and restrict communications between the hub controller and the switches in corresponding agricultural zones, and
whereby the hub controller transmits valve control signals to the wireless booster pump to pump water to the solenoid valve; and also transmits valve control signals to the switch to regulate opening and closing the solenoid valve.
